(19) United States
(12) Patent Application Publication
(10) Pub. No.: US 2015/0334057 A1
(43) Pub. Date: Nov. 19, 2015

(54) PACKET FORWARDING

(71) Applicant: HANGZHOU H3C TECHNOLOGIES CO., LTD., Hangzhou, Zhejiang (CN)

(72) Inventors: Ruichang GAO, Beijing (CN); Cong WANG, Beijing (CN)

(73) Assignee: Hangzhou H3C Technologies Co., Ltd., Hangzhou City (CN)

(21) Appl. No.: 14/651,576

(22) PCT Filed: Dec. 11, 2013
(86) PCT No.: PCT/CN2013/089043

§ 371 Date: Jun. 11, 2015

(30) Foreign Application Priority Data
Dec. 11, 2012 (CN) 201210538850.8

(51) Int. Cl. H04L 12/931; H04L 12/741; H04L 12/721

(52) U.S. Cl. CPC H04L 49/351; H04L 45/66; H04L 45/745

(57) ABSTRACT

According to an example, a method for forwarding an Ethernet packet may include receiving an Ethernet packet having a destination MAC address that is a MAC address of a gateway, selecting a port from multiple ports, wherein each of the ports of the multiple ports connects to one member device of a VRRP router that is working as the gateway; and sending the Ethernet packet via the selected port.

### BACKGROUND

In a local area network (LAN), hosts that belong to one segment are configured with the same default route, of which the next-hop is a gateway of the segment. Packets that are to be sent out of the LAN or sent to other segments in the LAN may be sent to the gateway via the default route. The gateway typically performs layer-3 forwarding based on a destination (IP) address of the packet. Communications between hosts in different network segments of a LAN and communications between a host in the LAN and an external network may be implemented.

### BRIEF DESCRIPTION OF THE DRAWINGS

Features of the present disclosure are illustrated by way of example and not limited in the following figure(s), in which like numerals indicate like elements, in which:

FIG. 1 is a flow chart illustrating a method for forwarding a packet using an access device in accordance with an example of the present disclosure;

FIG. 2 is a schematic diagram illustrating a structure of a LAN in accordance with a first example of the present disclosure;

FIG. 3 is a schematic diagram illustrating a structure of a LAN in accordance with a second example of the present disclosure;

FIG. 4 is a schematic diagram illustrating a structure of a LAN in accordance with a third example of the present disclosure;

FIG. 5 is a schematic diagram illustrating a structure of a LAN in accordance with a fourth example of the present disclosure; and

FIG. 6 is a schematic diagram illustrating structure of a network switch in accordance with an example of the present disclosure.

### DETAILED DESCRIPTION

For simplicity and illustrative purposes, the present disclosure is described by referring mainly to example(s) thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

The present disclosure provides a method for forwarding an Ethernet packet. The method may apply to an access device between a client terminal device and a VRRP group. The present disclosure is described hereinafter in detail with reference to the accompanying drawings and examples.

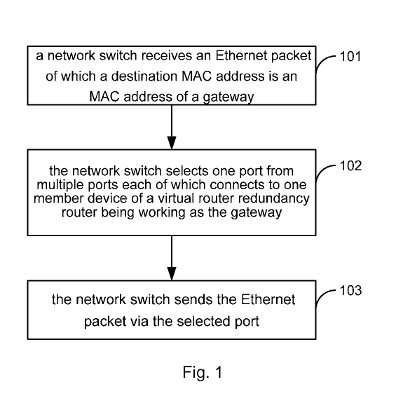

FIG. 1 is flow chart illustrating a method for forwarding a packet using an access device in accordance with an example of the present disclosure. As shown in FIG. 1, the method may include the following blocks.

In block 101, a network switch may receive an Ethernet packet having a destination media access control (MAC) address that is a MAC address of a gateway.

In block 102, the network switch may select a port from multiple ports, in which each of the ports of the multiple ports connects to a respective member device of a virtual router redundancy protocol (VRRP) router that is working as the gateway.

In block 103, the network switch may send the Ethernet packet via the selected port.

With the above method, a network switch, such as an access device, may load-balance the Ethernet packets being sent to the gateway for layer-3 forwarding among the member devices of a virtual router formed by the router devices acting as the gateways.

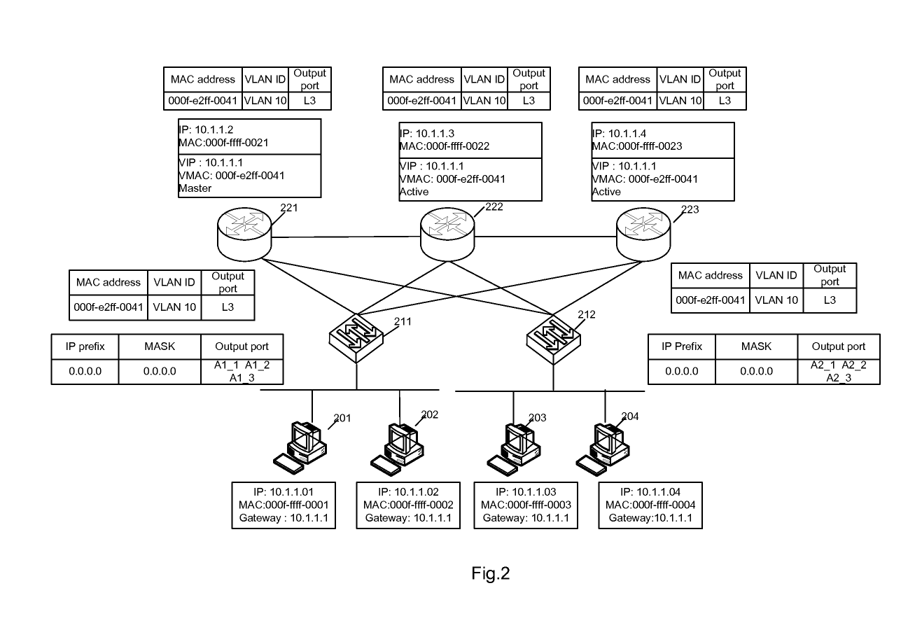

FIG. 2 is a schematic diagram illustrating a structure of a LAN in accordance with a first example of the present disclosure.

In FIG. 2, three ports on access device 211, which may respectively connect to router devices 221˜223, may be named as A1_{—}1, A1_{—}2, A1_{—}3, and two other ports on the access device 211, which may respectively connect to hosts 201 and 202, may be named as port1_{—}1 and port1_{—}2. Three ports on access device 212, which may respectively connect to router devices 221˜223, may be named as A2_{—}1, A2_{—}2, A2_{—}3, and two other ports on the access device 212, which may respectively connect to hosts 203 and 204, may be named as port2_{—}1, and port2_{—}2.

In FIG. 2, the ports on the router devices 221˜223, which may respectively connect to the access devices 211 and 212, may be configured as layer-3 Ethernet interfaces of VLAN 10. In an example, these layer-3 Ethernet interfaces have the same virtual IP address 10.1.1.1 and virtual MAC address 000f-e2ff-0041. In addition, each of the router devices 221˜223 may have one real MAC address and one real IP address (shown in FIG. 2). The router devices 221˜223 may perform neighbor discovery and election of a master device based on a virtual router redundancy protocol (VRRP). The three router devices 221˜223 may form one VRRP router, which may be configured as a gateway of virtual local area network (VLAN) 10. Each of the router devices 221-223 may be referred to as a “member device” of the VRRP router. By way of example, the router device 221 may be elected as the master router of the VRRP router and all three of the router devices 221˜223 may be in an active state, and may implement layer-3 forwarding for north-south traffic for VLAN 10. A static entry with a layer-3 attribute for the virtual MAC address 000f-e2ff-0041 may be configured in a layer-2 forwarding table of the router devices 221˜223.

In the example depicted in FIG. 2, a static entry with a layer-3 attribute for the virtual MAC address 000f-e2ff-0041 is configured in a layer-2 forwarding table of the access devices 211 and 212. A default route entry of which the output ports are ports A1_{—}1, A1_{—}2 and A1_{—}3 is configured in a layer-3 forwarding table of the access device 211. A default route entry of which the output ports are the ports A2_{—}1, A2_{—}2 and A2_{—}3 is configured in the layer-3 forwarding table of the access device 212.

Also in the example depicted in FIG. 2, the virtual IP address 10.1.1.1 is configured on the hosts 201˜204 as a default gateway IP address. The virtual MAC address 000f-e2ff-0041 is the MAC address of the default gateway.

According to the example depicted in FIG. 2, when the host 201 needs to send data to a destination device outside of the LAN, the host 201 may send an ARP request packet for a MAC address associated with the default gateway IP address, in which a sender MAC address is 000f-ffff-0001, a sender IP address is 10.1.1.01, a target MAC address is an all-zero MAC address, a target IP address is 10.1.1.1, a source MAC address is 000f-ffff-0001, and a destination MAC address is an all-F MAC address.

The access device 211 may receive the ARP request packet, may learn the MAC address of the host 201, and may broadcast the ARP request packet.

The router devices 221˜223 may respectively receive the ARP request packet, learn an ARP entry based on the sender MAC address 000f-ffff-0001 and the sender IP address 10.1.1.01 in the received ARP request packet, and learn a layer-2 forwarding entry based on the source MAC address 000f-ffff-0001 in the received ARP request packet.

The router device 221, which is the master router of the VRRP router in the example depicted in FIG. 2, may send an ARP response packet, in which, a sender MAC address is 000f-e2ff-0041, a sender IP address is 10.1.1.1, a target MAC address 000f-ffff-0001, a target IP address is 10.1.1.01, a source MAC address is 000f-ffff-0021, which is the real MAC address of the router device 221, a destination MAC address is 000f-ffff-0001, and the VLAN ID in the Ethernet header of the ARP response packet is VLAN 10.

The access device 211 may receive the ARP response packet from the router device 221, and may learn the real MAC address of the router device 221 based on the source MAC address in the received ARP response packet. The layer-2 forwarding table of the access device 211 may at least store entries shown in table 1.

TABLE 1

| MAC address | VLAN ID | output port |
|---|---|---|
| 000f-e2ff-0041 | VLAN 10 | L3 |
| 000f-ffff-0001 | VLAN 10 | port1_1 |
| 000f-ffff-0021 | VLAN 10 | A1_1 |

The access device 211 may search the layer-2 forwarding table with the destination MAC address 000f-ffff-0001 and VLAN 10, may find a matching entry (shown in the third row in the table 1), and may send the ARP response packet to the host 201 via the port 1_{—}1 in the matching entry.

The host 201 may receive the ARP response packet from the router device 221, and may learn an ARP entry corresponding to the default gateway IP address 10.1.1.1 based on the sender MAC address 000f-e2ff-0041 and the sender IP address 10.1.1.1. The host 201 may send an Ethernet packet carrying data, which needs to be sent to a destination device outside the LAN, to the default gateway. In the Ethernet packet sent by the host 201 to the gateway, a source MAC address is 000f-ffff-0001, a destination MAC address is 000f-e2ff-0041, a source IP address is 10.1.1.01, and a destination IP address is 10.2.2.01, which is an IP address of the destination device.

The access device 211 may receive the Ethernet packet from the host 201, may find a matching entry with layer-3 attribute in the layer-2 forwarding table based on the destination MAC address 000f-e2ff-0041 and VLAN 10, and may find a defult route entry in the layer-3 forwarding table based on the destination IP address 10.2.2.01 of the received Ethernet packet. The access device 211 may perform hash calculation based on the received Ethernet packet, and may select the output port A1_{—}3 from the output ports A1_{—}1, A1_{—}2 and A1_{—}3 in the default route entry.

The access device 211 may send the Ethernet packet sent by the host 201 to the router device 223 via the output port A1_{—}3.

The router device 223 may receive the Ethernet packet sent by the host 201, may find a matching entry with layer-3 attribute in the layer-2 forwarding table based on the destination MAC address 000f-e2ff-0041 of the received Ethernet packet, may remove the Ethernet header of the received Ethernet packet, and may perform upstream layer-3 forwarding based on the destination IP address 10.2.2.01.

When the router device 223 performs layer-3 forwarding based on a destination IP address 10.1.1.01 of a downstream layer-3 packet, the router device 223 may search its ARP table, may find the ARP entry having the IP address 10.1.1.01 and the MAC address 000f-ffff-0001, and may encapsulate the layer-3 packet into an Ethernet packet based on the found ARP entry and its real MAC address 000f-ffff-0023. In the Ethernet packet destined for the IP address 10.1.1.01, the source MAC address is 000f-ffff-0023, and the destination MAC address is 000f-ffff-0001. The router device 223 may send the Ethernet packet via an output port in the found ARP entry.

When the router device 221 performs layer-3 forwarding based on a destination IP address 10.1.1.03 of a downstream layer-3 packet, the router device 221 may search its ARP table with the destination IP address 10.1.1.03, and may send an ARP request packet if there is no matching entry for the destination IP address 10.1.1.03. In the ARP request packet sent by the router device 221, the sender MAC address is 000f-ffff-0021, which is the real MAC address of the router device 221, the sender IP address is 10.1.1.2, which is the real IP address of the router device 221, the target MAC address is an all-zero MAC address, the target IP address is 10.1.1.03, which is the destination IP address of the downstream layer-3 packet, the source MAC address is 000f-ffff-0021, the destination MAC address is an all-F MAC address.

When the access device 212 receives the ARP request packet from the router device 221, the access device 212 may learn the real MAC address 000f-ffff-0021 of the router device 221 and may broadcast the ARP request packet in the VLAN 10.

The host 203 may receive the ARP request packet, may learn an ARP entry based on the sender MAC address 000f-ffff-0021 and the sender IP address 10.1.1.2, and may send an ARP response packet, in which the sender MAC address is 000f-ffff-0003, the sender IP address is 10.1.1.03, the target MAC address is 000f-ffff-0021, the target IP address is 10.1.1.2, the source MAC address is 000f-ffff-0003, and the destination MAC address is 000f-ffff-0021.

The access device 212 may receive the ARP response packet from the host 203 and may learn the MAC address of the host 203 (shown in the last row in the table 1-1). The layer-2 forwarding table of the access device 212 may at least store entries as shown in table 1-1.

TABLE 1-1

| MAC address | VLAN ID | output port |
|---|---|---|
| 000f-e2ff-0041 | VLAN 10 | L3 |
| 000f-ffff-0021 | VLAN 10 | A2_1 |
| 000f-ffff-0003 | VLAN 10 | Port2_1 |

The access device 212 may find a matching entry based on the destination MAC address 000f-ffff-0021 and the VLAN 10, and may forward the ARP respone packet to the router device 221 via the output port A2_{—}1 in the matching entry (shown in the third row in the table1-1).

The router device 221 may learn an ARP entry based on the sender MAC address 000f-ffff-0003 and the sender IP address 10.1.1.03 in the ARP response packet, and may learn a MAC address entry based on the source MAC address 000f-ffff-0003 in the received ARP response packet.

The router device 221 may encapsulate the downstream layer-3 packet destined for host 203 into an Ethernet packet, in which the source MAC address is 000f-ffff-0021, the destination MAC address is 000f-ffff-0003, and the VLAN ID is VLAN 10. The router device 221 may send the encapsulated Ethernet packet via an output port in the learned ARP entry.

As shown in FIG. 2, the access device 211 may select one port from the three ports in the default route entry based on a load-balance algorithm and may take the selected port as a port of an Equal-Cost path from the access device 211 to the VRRP group. The access device 211 may for example calculate a hash value based on characteristic information of the Ethernet packet sent by the host 201, compute a modulus result of the hash value modulo number of output ports in the found static default route entry, and send the received Ethernet packet from the host 201 via one port matching the computed modulus result. The characteristic parameters of the Ethernet packet used for hash calculation may be a source IP address, a source MAC address, and 5-tuple information or 7-tuple information. The 5-tuple information may include a source IP address, a destination IP address, a source port number, a destination port number, and a protocol type. The 7-tuple information may include an interface type, a source IP address, a destination IP address, a source port number, a destination port number, a protocol type, and a Type of Service (TOS). The present example does not make limitation on the method for executing the hash calculation by the access device 211.

The router devices 221˜223 in the VRRP group may learn the ARP entry based on the ARP request packet through other methods. For instance, the router device 221, which, in the example of FIG. 2 is the master router in the VRRP group, may learn an ARP entry based on a sender IP address and a sender MAC address in a received ARP request packet sent by a host, and may synchronize the learned ARP entry to other member devices, such as the router devices 222˜223, in the VRRP group.

In order to remove a failed router device in time and reduce traffic interruption time resulting from the failed router device, the access devices 211 and 212 may establish a link state monitoring session with each member device in the VRRP group to monitor the link state of each member device connected with the access device.

For instance, the access device 211 may establish a Bidirectional Forwarding Detection (BFD) session based on the real IP addresses of the router devices 221, 222, and 223. The BFD session may be used to monitor the states of the links by which the ports A1_{—}1, A1_{—}2, and A1_{—}3 on the access device 211 are connected to the layer-3 Ethernet interfaces of the router devices 221, 222, and 223.

When the access device 211 detects that one of the ports A1_{—}1˜A1_{—}3 is on a failed link, which connects to a layer-3 Ethernet interface on one of the member devices in the VRRP group, the access device 211 may delete the port on the failed link from the default route entry. When the access device 211 detects that the failed link has been recovered by the link state monitoring session, the access device 221 may add the port on the recovered link to the default route entry.

When the access devices 211 and 212 forward Ethernet packets of which the destination MAC addresses are the virtual MAC address 000f-e2ff-0041, the access devices 211 and 212 may control the TTL and VLAN of these upstream Ethernet packets and keep the source MAC addresses and destination MAC addresses of these upstream Ethernet packets unchanged.

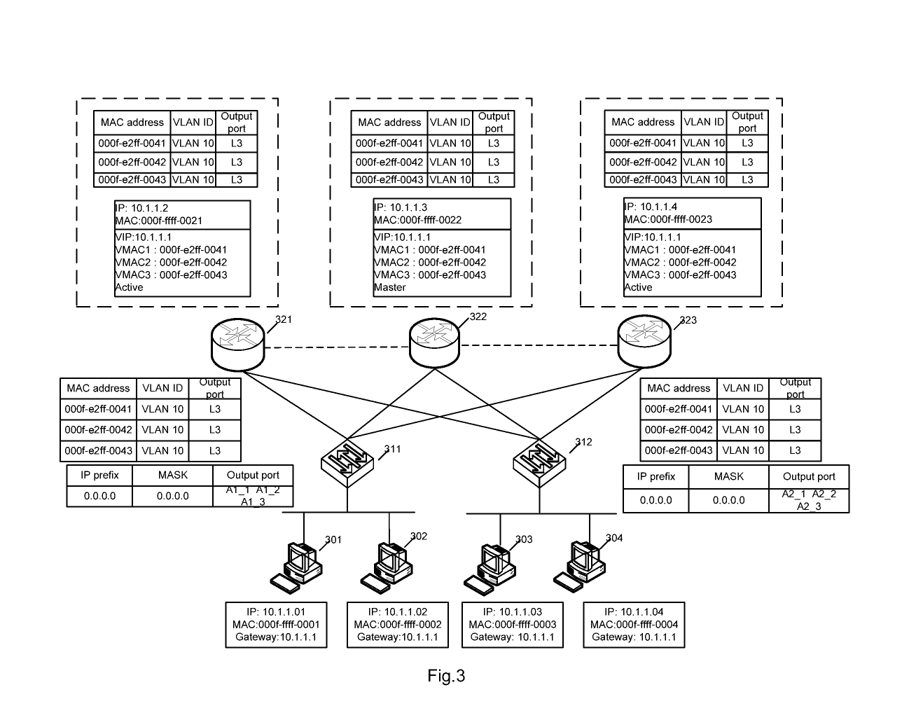

FIG. 3 is a schematic diagram illustrating a structure of a LAN in accordance with a second example of the present disclosure. In this second example the VRRP has a plurality of virtual MAC addresses.

Three ports on access device 311, which may respectively connect to router devices 321˜323, may be named as A1_{—}1, A1_{—}2, A1_{—}3, and two other ports on the access device 311, which may respectively connect to hosts 301 and 302 may be named as port1_{—}1 and port1_{—}2. Three ports on access device 312, which may respectively connect to router devices 321˜323, may be named as A2_{—}1, A2_{—}2, A2_{—}3, and two other ports on the access device 312, which may respectively connect to hosts 303 and 304, may be named as port2_{—}1, and port2_{—}2.

The ports on the router devices 321˜323, which may respectively connect to the access devices 311 and 312, may be configured as layer-3 Ethernet interfaces of VLAN 10. In an example, these layer-3 Ethernet interfaces may have the same virtual IP address 10.1.1.1 and virtual MAC addresses 000f-e2ff-0041, 000f-e2ff-0042, and 000f-e2ff-0043. In addition, each of the router devices 321˜323 may have one real MAC address and one real IP address (shown in FIG. 3). The router devices 321˜323 may form one VRRP router, which may be configured as a gateway of VLAN 10. By way of example, the router device 322 may be elected as the master router of the VRRP router. All three router devices 321˜323 may be in an active state and may perform layer-3 forwarding for north-south traffic between VLAN 10 and an external network and east-west traffic between VLAN 10 and other VLANs in the LAN. A static entry with a layer-3 attribute for the virtual MAC address may be configured in a layer-2 forwarding table of the router devices 321˜323. In the example shown in FIG. 3, the virtual MAC addresses 000f-e2ff-0041, 000f-e2ff-0042, and 000f-e2ff-0043 are MAC addresses of the default gateway.

As shown in the FIG. 3, in the layer 2 forwarding table of the access device 311, static entries with layer-3 attribute may be configured for the three virtual MAC addresses. A default route entry, of which output ports are ports A1_{—}1, A1_{—}2, and A1_{—}3 may be configured in a layer-3 forwarding table of the access device 311. In the layer 2 forwarding table of the access device 312, static entries with layer-3 attribute are configured for the three virtual MAC addresses. A default route entry, of which output ports are the ports A2_{—}1, A2_{—}2, and A2_{—}3, may be configured in the layer-3 forwarding table of the access device 312.

The virtual IP address 10.1.1.1 may be configured on the hosts 301˜304 as a default gateway IP address.

When the host 303 needs to send data to a destination outside of the LAN, the host 303 may send an ARP request packet for a MAC address associated with the default gateway IP address10.1.1.1, in which a sender MAC address is 000f-ffff-0003, a sender IP address is 10.1.1.03, a target MAC address is an all-zero MAC address, a target IP address is 10.1.1.1, a source MAC address is 000f-ffff-0003, and a destination MAC address is an all-F MAC address.

The access device 312 may receive the ARP request packet, learn the MAC address of the host 303, and broadcast the ARP request packet in VLAN 10.

The router devices 321˜323 may receive the ARP request packet from the host 303 and learn an ARP entry based on the sender MAC address 000f-ffff-0003 and the sender IP address 10.1.1.03. The router device 322 may select the virtual MAC address 000f-e2ff-0042 from the three virtual MAC addresses based on a load-balance algorithm, and may send an ARP response packet, in which a sender MAC address is the selected virtual MAC address 000f-e2ff-0042, a sender IP address is 10.1.1.1, a target MAC address is 000f-ffff-0003, a target IP address is 10.1.1.03, a source MAC address is 000f-ffff-0022, which is a real MAC address of the router device 322, a destination MAC address is 000f-ffff-0003, and a VLAN ID is VLAN 10.

The access device 312 may receive the ARP response packet from the router device 322 and may learn the real MAC address of the router device 322 (shown in the last row in the table 2). The layer-2 forwarding table of the access device 312 may at least store entries as shown in table 2.

TABLE 2

| MAC address | VLAN ID | output port |
|---|---|---|
| 000f-e2ff-0041 | VLAN 10 | L3 |
| 000f-e2ff-0042 | VLAN 10 | L3 |
| 000f-e2ff-0043 | VLAN 10 | L3 |
| 000f-ffff-0003 | VLAN 10 | port2_1 |
| 000f-ffff-0022 | VLAN 10 | A2_2 |

The access device 312 may find a matching entry based on the destination MAC address 000f-ffff-0003 and VLAN 10 (shown in the fifth row in the table 2) and may send the ARP response PACKET to the host 303 via the port 2_{—}1 in the matching entry.

The host 303 may receive the ARP response packet sent by the router device 322 and may learn an ARP entry corresponding to the default gateway IP address based on the sender MAC address 000f-e2ff-0042 and the sender IP address 10.1.1.1. That is, the host 303 may store a corresponding relationship between the virtual IP address 10.1.1.1 and virtual MAC address 000f-e2ff-0042 in the ARP entry. The host 303 may send an Ethernet packet carrying data that needs to be sent to a destination device outside the LAN to the default gateway. In the Ethernet packet from the host 303, the source MAC address is 000f-ffff-0003, the destination MAC address is 000f-e2ff-0042, the source IP address is 10.1.1.03, and the destination IP address is 10.2.2.01, which is an IP address of the destination device.

The access device 312 may receive the Ethernet packet sent by the host 303, may find a matching entry with a layer-3 attribute in the layer-2 forwarding table based on the destination MAC address 000f-e2ff-0042 (shown in the third row in the table 2), and may find a defult route entry in the layer-3 forwarding table based on the destination IP address 10.2.2.01 of the received Ethernet packet. The access device 312 may perform a hash calculation based on the received Ethernet packet and may select the output port A2_{—}3 from the output ports A2_{—}1, A2_{—}2, and A2_{—}3 in the default route entry.

The access device 312 may send the Ethernet packet sent by the host 303 via the port A2_{—}3.

The router device 323 may receive the Ethernet packet sent by the host 303, find a matching entry with layer-3 attribute in the layer-2 forwarding table based on the destination MAC address 000f-e2ff-0042(shown in FIG. 3), remove the Ethernet header of the received Ethernet packet, and perform layer-3 forwarding based on the destination IP address 10.2.2.01.

When the router device 323 performs layer-3 forwarding based on a destination IP address 10.1.1.03 of a downstream layer-3 packet, the router device 323 may search its ARP table, find the ARP entry having the IP address 10.1.1.03 and a MAC address 000f-ffff-0003, and encapsulate the layer-3 packet into an Ethernet packet based on the found ARP entry and its real MAC address 000f-ffff-0023. In the Ethernet packet having the destination IP address 10.1.1.03, the source MAC address is 000f-ffff-0023 and the destination MAC address is 000f-ffff-0003. The router device 323 may forward the Ethernet packet via an output port in the found ARP entry.

When the router device 321 performs layer-3 forwarding based on a destination IP address 10.1.1.01 of a downstream layer-3 packet, the router device 321 may search its ARP table with the destination IP address 10.1.1.01, and may send an ARP request packet if there is no matching entry for the IP address 10.1.1.01. In the ARP request sent by the router device 321, the sender MAC address is 000f-ffff-0021, which is the real MAC address of the router device 321, the sender IP address is 10.1.1.2, which is the real IP address of the router device 321, the target MAC address is an all-zero MAC address, the target IP address is 10.1.1.01, which is the destination IP address of the layer-3 packet, the source MAC address is 000f-ffff-0021, and the destination MAC address is an all-F MAC address.

When the access device 311 receives the ARP request packet from the router device 321, the access device 311 may learn the real MAC address of the router device 321 (shown in the fifth row in table 2-1) and may broadcast the ARP request packet in the VLAN 10.

The host 301 may receive the ARP request packet, learn an ARP entry based on the sender MAC address 000f-ffff-0021 and the sender IP address 10.1.1.2, and may send the ARP response packet, in which the sender MAC address is 000f-ffff-0001, the sender IP address is 10.1.1.01, the target MAC address is 000f-ffff-0021, the target IP address is 10.1.1.2, the source MAC address is 000f-ffff-0001, and the destination MAC address is 000f-ffff-0021.

The access device 311 may receive the ARP response packet from the host 301 and may learn the MAC address of the host 301 (shown in the last row in the table 2-1). The layer-2 forwarding table of the access device 311 may at least store entries as shown in table 2-1.

TABLE 2-1

| MAC address | VLAN ID | output port |
|---|---|---|
| 000f-e2ff-0041 | VLAN 10 | L3 |
| 000f-e2ff-0042 | VLAN 10 | L3 |
| 000f-e2ff-0043 | VLAN 10 | L3 |
| 000f-ffff-0021 | VLAN 10 | A1_1 |
| 000f-ffff-0001 | VLAN 10 | port1_1 |

The access device 311 may find a matching entry based on the destination MAC address 000f-ffff-0021 and the VLAN 10, and may send the ARP response packet to the router device 321 via the output port A1_{—}1 in the matching entry.

The router device 321 may learn an ARP entry based on the sender MAC address 000f-ffff-0001 and the sender IP address 10.1.1.01 in the received ARP response packet, and may learn a MAC entry based on the source MAC address 000f-ffff-0001 in the received ARP response packet.

The router device 321 may encapsulate the downstream layer-3 packet having the destination IP address10.1.1.01 into an Ethernet packet, in which a source MAC address is 000f-ffff-0021, a destination MAC address is 000f-ffff-0001, and a VLAN ID is VLAN 10. The router device 321 may send the encapsulated Ethernet packet via an output in the learned ARP entry.

The access devices 311 and 312 may establish a link state monitoring session with each member device in the VRRP group. For instance, the access device 311 may establish a Bidirectional Forwarding Detection (BFD) session with the real IP addresses of the router devices 321, 322, and 323. The BFD session may be used to monitor the states of the links between the ports A1_{—}1, A1_{—}2, and A1_{—}3 of the access device 311 and the layer-3 Ethernet interfaces of the router devices 321, 322, and 323.

When the access device 311 detects that one of the ports A1_{—}1˜A1_{—}3 is on a failed link, the access device 311 may delete the port on the failed link from the default route entry. When the access device 311 detects that the failed link has been recovered, the access device 321 may add the port on the recovered link to the default route entry.

The access devices 311 and 312 may load-balance the packets, which may be sent to the VRRP router for layer 3 forwarding, among the router devices 321˜323. Each member device of the virtual router may perform layer-3 forwarding/routing of the layer-2 Ethernet packet. The access devices 311 and 312 may balance the packets from the same host among different member devices based on different types of services.

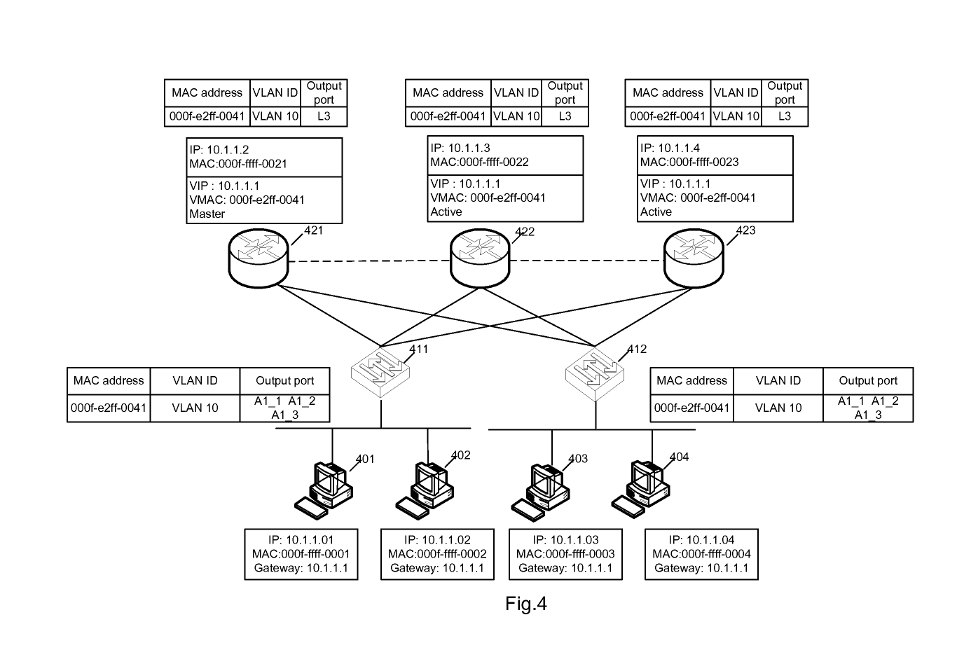

FIG. 4 is a schematic diagram illustrating a structure of a LAN in accordance with a third example of the present disclosure.

Three ports on access device 411, which may respectively connect to router devices 421˜423, may be named as A1_{—}1, A1_{—}2, A1_{—}3, and two other ports on the access device 411, which may respectively connect to hosts 401 and 402, may be named as port1_{—}1 and port1_{—}2. Three ports on access device 412, which may respectively connect to router devices 421˜423, may be named as A2_{—}1, A2_{—}2, A2_{—}3, and two other ports on the access device 412, which may respectively connect to hosts 403 and 404 may be named as port2_{—}1, and port2_{—}2.

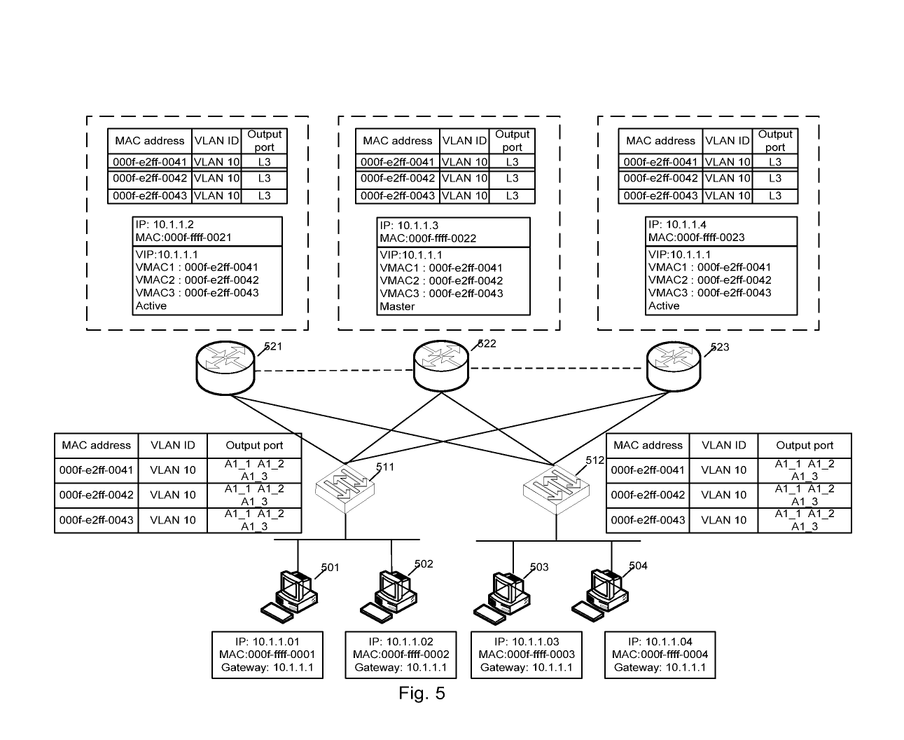

The ports on the router devices 421˜423, which may respectively connect to the access devices 411 and 412, may be configured as layer-3 Ethernet interfaces of VLAN 10. In an example, these layer-3 Ethernet interfaces have the same virtual IP address 10.1.1.1 and virtual MAC address 000f-e2ff-0041. In addition, each of the router devices 421˜423 may have one real MAC address and one real IP address (shown in FIG. 5). The router devices 421˜423 may form one VRRP router, which may be configured as a gateway of VLAN 10. By way of example, the router device 421 may be elected as the master router of the VRRP router, all three of the router devices 421˜423 may be in an active state and may implement layer-3 forwarding for north-south traffic between the VLAN 10 and an external network and east-west traffic between VLAN 10 and other VLANs in the LAN. A static entry for the virtual MAC address 000f-e2ff-0041 may be configured in layer-2 forwarding tables of the router devices 421˜423.

As shown in the FIG. 4, in the layer-2 forwarding tables of the access device 411, a static forwarding entry of which output ports are the ports A1_{—}1, A1_{—}2 and A1_{—}3 is configured for the virtual MAC address, and in the layer-2 forwarding tables of the access device 412, a static forwarding entry of which output ports are the ports A2_{—}1, A2_{—}2 and A2_{—}3 is configured for the virtual MAC address.

The virtual IP address 10.1.1.1 may be configured on the hosts 401˜404 as a default gateway IP address. The virtual MAC address 000f-e2ff-0041 may be the MAC address of the default gateway.

When the host 401 needs to send data to a destination device outside of the LAN or to a host in another VLAN in the LAN (not shown in FIG. 4), the host 401 may send an ARP request packet for a MAC address associated with the default gateway IP address10.1.1.1, in which a sender MAC address is 000f-ffff-0001, a sender IP address is 10.1.1.01, a target MAC address is an all-zero MAC address, a target IP address is 10.1.1.1, a source MAC address is 000f-ffff-0001, and a destination MAC address is an all-F MAC address.

The access device 411 may receive the ARP request packet, learn the MAC address of the host 401 (as shown in the third row in the table 4) and broadcast the ARP request packet in the VLAN 10.

The router devices 421˜423 may receive the ARP request packet sent by the host 401, learn an ARP entry based on the sender MAC address 000f-ffff-0001 and the sender IP address 10.1.1.01 in the received ARP request packet, learn a forwarding entry based on the source MAC address 000f-ffff-0001 in the ARP request packet. The router device 421, which is the master router of the VRRP router in the example depicted in FIG. 4, may send the ARP response packet, in which a sender MAC address is 000f-e2ff-0041, which is the virtual MAC address shown in FIG. 4, a sender IP address is 10.1.1.1, which is the virtual IP address shown in FIG. 4, a target MAC address is 000f-ffff-0001, a target IP address is 10.1.1.01, a source MAC address is 000f-ffff-0021, a destination MAC address is 000f-ffff-0001, and a VLAN ID is VLAN 10.

The access device 411 may receive the ARP response packet from the router device 421, and learn the real MAC address 000f-ffff-0021 of the router device 421 based on the destination MAC address in the received ARP response packet (as shown in the last row in the table 3). The layer-2 forwarding table of the access device 411 may at least store entries as shown in table 3.

TABLE 3

| MAC address | VLAN ID | output port |
|---|---|---|
| 000f-e2ff-0041 | VLAN 10 | A1_1 A1_2 A1_3 |
| 000f-ffff-0001 | VLAN 10 | port1_1 |
| 000f-ffff-0021 | VLAN 10 | A1_1 |

The access device 411 may search the layer-2 forwarding table with the destination MAC address 000f-ffff-0001 and VLAN 10, find a matching entry (shown in the third row in table 3), and send the ARP respone packet to the host 401 via the output port 1_{—}1 in the matching entry.

The host 401 may receive the ARP response packet from the router device 421 and learn an ARP entry corresponding to the default gateway IP address 10.1.1.1 based on the sender MAC address 000f-e2ff-0041 and the sender IP address 10.1.1.1. The host 401 may send an Ethernet packet to the default gateway. In the Ethernet packet sent by the host 401, the source MAC address is 000f-ffff-0001, the destination MAC address is 000f-e2ff-0041, the source IP address is 10.1.1.01 and the destination IP address is 10.2.2.01, which is an IP address of the destination outside of the LAN.

The access device 411 may receive the Ethernet packet from the host 401, find a matching entry (shown in the second row in the table 3) based on the destination MAC address 000f-e2ff-0041 and VLAN10, perform hash calculation based on the received Ethernet packet, and select the output port A1_{—}3 from the output ports A1_{—}1, A1_{—}2 and A1_{—}3 in the matching entry.

The access device 411 may send the Ethernet packet sent by the host 401 via the port A1_{—}3.

The router device 423 may receive the Ethernet packet sent by the host 401, find a matching entry with layer-3 attribute by searching the layer-2 forwarding table with the destination MAC address 000f-e2ff-0041, delete the Ethernet header of the Ethernet packet and perform layer-3 forwarding based on the destination IP address 10.2.2.01.

When the router device 423 performs layer-3 forwarding based on a destination IP address 10.1.1.01 of a downstream layer-3 packet, the router device 423 may search its ARP table, find a matching ARP entry having an IP address 10.1.1.01 and a MAC address 000f-ffff-0001, and encapsulate the layer-3 packet into an Ethernet packet based on the matching ARP entry and its real MAC address 000f-ffff-0023. In the Ethernet packet having the destination IP address 10.1.1.01, the source MAC address is 000f-ffff-0023, and the destination MAC address is 000f-ffff-0001. The router device 223 may send the Ethernet packet via an output port in the found the ARP entry.

When the router device 421 performs layer-3 forwarding based on a destination IP address 10.1.1.03 of a downstream layer-3 packet, the router device 421 may search its ARP table with the destination IP address 10.1.1.03, and send an ARP request packet if there is no matching entry for the destination IP address 10.1.1.03. In the ARP request packet sent by the router device 421, the sender MAC address is 000f-ffff-0021, which is the real MAC address of the router device 421, the sender IP address is 10.1.1.2, which is the real IP address of the router device 421, the target MAC address is an all-zero MAC address, the target IP address is 10.1.1.03, which is the destination IP address of the downstream layer-3 packet, the source MAC address is 000f-ffff-0021, and the destination MAC address is an all-F MAC address.

When the access device 412 receives the ARP request packet from the router device 421, the access device 412 may learn the real MAC address of the router device 421 (shown in the third row in the table 4-1) and broadcast the ARP request packet in the VLAN 10.

The host 403 may receive the ARP request packet, learn an ARP entry based on the sender MAC address 000f-ffff-0021 and the sender IP address 10.1.1.2, and send an ARP response packet, in which the sender MAC address is 000f-ffff-0003, the sender IP address is 10.1.1.03, the target MAC address is 000f-ffff-0021, the target IP address is 10.1.1.2, the source MAC address is 000f-ffff-0003, and the destination MAC is 000f-ffff-0021.

The access device 412 may receive the ARP response packet from the host 403 and may learn the MAC address of the host 403 (shown in the last row in the table 3-1). The layer-2 forwarding table of the access device 412 may at least store entries as shown in table 3-1.

TABLE 3-1

| MAC address | VLAN ID | output port |
|---|---|---|
| 000f-e2ff-0041 | VLAN 10 | A1_1 A1_2 A1_3 |
| 000f-ffff-0021 | VLAN 10 | A2_1 |
| 000f-ffff-0001 | VLAN 10 | port2_1 |

The access device 412 may find a matching entry (shown in the third row in the table 3-1) based on the destination MAC address 000f-ffff-0021 and the VLAN 10 of the ARP response packet, and send the ARP respone packet to the router device 421 via the output port A2_{—}1 in the matching entry.

The router device 421 may learn an ARP entry based on the sender MAC address 000f-ffff-0003 and the sender IP address 10.1.1.03 in the ARP response packet, and may learn a MAC entry based on the source MAC address 000f-ffff-0003 in the received ARP response packet.

The router device 421 may encapsulate the downstream layer-3 packet having the destination IP address 10.1.1.03 into an Ethernet packet, in which the source MAC address is 000f-ffff-0021, the destination MAC address is 000f-ffff-0003, and the VLAN ID is VLAN 10. The router device 421 may send the Ethernet packet via an output port in learned ARP entry.

In FIG. 4, the access device 411 or access device 412 may select one output port from the three output ports in the static layer-2 forwarding entry corresponding to the virtual MAC address based on different hash algorithms, which are not described in detail in this example.

The access devices 411 and 412 may establish a link state monitoring session with each member device in the VRRP group, such as a BFD session. The link state monitoring session may be used to monitor the state of the link connecting the access device and each member device.

The access device 411 or access device 412 may delete ports on the failed link from the output ports in the static virtual MAC address entry (entries shown in the second row in table 3 and the second row in table 3-1), and may add ports on the recovered links to the output ports in the static virtual MAC address entries.

FIG. 5 is a schematic diagram illustrating a structure of a LAN in accordance with a fourth example of the present disclosure.

Three ports on access device 511, which may respectively connect to router devices 521˜523, may be named as A1_{—}1, A1_{—}2, A1_{—}3, and two other ports on the access device 511, which may respectively connect to hosts 501 and 502, may be named as port1_{—}1 and port1_{—}2. Three ports on access device 512, which may respectively connect to router devices 521˜523, may be named as A2_{—}1, A2_{—}2, A2_{—}3, and two other ports on the access device 512, which may respectively connect to hosts 503 and 504, may be named as port2_{—}1, and port2_{—}2.

The ports on the router devices 521˜523, which may respectively connect to the access devices 511 and 512, may be configured as layer-3 Ethernet interfaces of VLAN 10. In this example, these layer-3 Ethernet interfaces may have the same virtual IP address 10.1.1.1 and virtual MAC addresses 000f-e2ff-0041, 000f-e2ff-0042 and 000f-e2ff-0043. Each of the router devices 521˜523 has one real MAC address and one real IP address (shown in FIG. 5). The router devices 521˜523 may form one VRRP router, which may be configured as a gateway of VLAN 10. By way of example, the router device 522 may be elected as the master router of the VRRP router. All three router devices 521˜523 may be in an active state and may implement layer-3 forwarding for north-south traffic for VLAN 10 and an external network and east-west traffic between VLAN 10 and other VLANs in the LAN. Static entries for the three virtual MAC addresses may respectively be configured in a layer-2 forwarding table of the router devices 521˜523.

In a layer-2 forwarding table of the router device 511, static entries with layer-3 attribute are configured for the virtual MAC addresses, In a layer-2 forwarding table of the router device 513, static entries with layer-3 attributes may be configured for the virtual MAC addresses.

The virtual IP address 10.1.1.1 may be configured on the hosts 501˜504 as a default gateway IP address. The virtual MAC address 000f-e2ff-0041, 000f-e2ff-0042, and 000f-e2ff-0043 may be MAC addresses of the default gateway.

When the host 503 needs to send data to a destination device outside of the LAN network, the host 503 may send an ARP request packet for a MAC address associated with the default gateway IP address10.1.1.1, in which a sender MAC address is 000f-ffff-0003, a sender IP address is 10.1.1.03, a target MAC address is an all-zero MAC address, a target IP address is 10.1.1.1, a source MAC address is 000f-ffff-0003, and a destination MAC address is an all-F MAC address.

The access device 512 receives the ARP request packet, learns the MAC address of the host 503 and broadcasts the ARP request packet in VLAN10.

The router devices 521˜523 may receive the ARP request packet sent by the host 503, learn an ARP entry based on the sender MAC address 000f-ffff-0003 and the sender IP address 10.1.1.03 in the received ARP request packet, and learn a forwarding entry based on the source MAC address 000f-ffff-0003 in the ARP request packet. The router device 522, which may be the master router of the VRRP router, may send an ARP response packet, in which a sender MAC address is 000f-e2ff-0042, a sender IP address is 10.1.1.1, a target MAC address is 000f-ffff-0003, a target IP address is 10.1.1.03, a source MAC address is 000f-ffff-0022, which is the real MAC address (shown in FIG. 5), a destination MAC address is 000f-ffff-0003, and a VLAN ID is VLAN 10.

The access device 512 may receive the ARP response packet from the router device 522 and learn the real MAC address 000f-ffff-0022 of the router device 522 (shown in the last row in the table 4). The layer-2 forwarding table of the access device 512 may at least store entries as shown in table 4.

TABLE 4

| MAC address | VLAN ID | output port |
|---|---|---|
| 000f-e2ff-0041 | VLAN 10 | A2_1 A2_2 A2_3 |
| 000f-e2ff-0042 | VLAN 10 | A2_1 A2_2 A2_3 |
| 000f-e2ff-0043 | VLAN 10 | A2_1 A2_2 A2_3 |
| 000f-ffff-0003 | VLAN 10 | port2_1 |
| 000f-ffff-0022 | VLAN 10 | A2_2 |

The access device 512 may find a matching entry (shown in the fifth row in the table 4) based on the destination MAC address 000f-ffff-0003 and the VLAN 10, and send the ARP respons packet to the host 503 via the port 2_{—}1 in the matching entry.

The host 503 may receive the ARP response packet from the router device 522, and learn an ARP entry corresponding to the default gateway IP address based on the sender IP address 10.1.1.1 and the sender MAC address 000f-e2ff-0042. The host 503 may send Ethernet carrying data for a destination device outside of the LAN to the default gateway. In the example shown in FIG. 5, in the Ethernet packet sent by the host 503, the source MAC address is 000f-ffff-0003, the destination MAC address is 000f-e2ff-0042, the source IP address is 10.1.1.03, and the destination IP address is 10.2.2.01, which is an IP address of the destination device.

The access device 512 may receive the Ethernet packet sent by the host 503, find a matching entry in the layer-2 forwarding table based on the destination MAC address 000f-e2ff-0042 (shown in the third row in the table 4), send the Ethernet packet via output port A2_{—}3 being selected from the output ports A2_{—}1, A2_{—}2 and A2_{—}3 in the found route entry. The access device 312 may perform a hash calculation based on the received Ethernet packet, and select an output port based on hash calculation result.

The router device 512 may send the Ethernet packet from the host 503 to the router device 523 via the port A2_{—}3. The router device 523 may find an entry with layer-3 attribute in the layer-2 forwarding table based on the destination MAC address 000f-e2ff-0042 of the Ethernet packet, and delete the Ethernet header of the Ethernet packet and perform layer-3 forwarding based on the destination IP address 10.2.2.01. The upstream layer-3 forwarding processing performed by the router device 523 is not described in detail in this example.

When the router device 523 performs layer-3 forwarding based on a destination IP address 10.1.1.03 of a downstream layer-3 packet, the router device 523 may search its ARP table, find the ARP entry having the IP address 10.1.1.03 and the MAC address 000f-ffff-0003, and encapsulate the layer-3 packet having a destination IP address 10.1.1.03 into an Ethernet packet based on the found ARP entry and its real MAC address 000f-ffff-0023. In this example, the IP address of the Ethernet packet is 10.1.1.03, the source MAC address is 000f-ffff-0023, and the destination MAC address is 000f-ffff-0003. The router device 523 may forward the Ethernet packet via an output port in the found ARP entry.

When the router device 521 performs layer-3 forwarding based on a destination IP address 10.1.1.01 of a downstream layer-3 packet, the router device 521 may search its ARP table with destination IP address 10.1.1.01, and send an ARP request packet if there is no matching entry for the IP address 10.1.1.01. In the ARP request sent by the router device 521, the sender MAC address is 000f-ffff-0021, which is the real MAC address of the router device 521, the sender IP address is 10.1.1.2, which is the real IP address of the router device 521, the target MAC address is an all-zero MAC address, the target IP address is 10.1.1.01, which is the destination IP address of the layer-3 packet, the source MAC address is 000f-ffff-0021, and the destination MAC address is an all-F MAC address.

The access device 511 may receive the ARP request packet from the router device 521, learn the real MAC address of the router device 521, and broadcast the ARP request packet in the VLAN 10.

The host 501 may receive the ARP request packet, learn an ARP entry based on the sender MAC address 000f-ffff-0021 and the IP address 10.1.1.2 in the ARP request packet, and send an ARP response packet, in which the sender MAC address is 000f-ffff-0001, the sender IP address is 10.1.1.01, the target MAC address is 000f-ffff-0021, the target IP address is 10.1.1.2, the source MAC address is 000f-ffff-0001, and the destination MAC address is 000f-ffff-0021.

The access device 511 may receive the ARP response packet from the host 501 and learn the MAC address of the host 501 (shown in the last row in the table 4-1). The layer-2 forwarding table of the access device 511 may at least store entries as shown in table 4-1.

TABLE 4-1

| MAC address | VLAN ID | output port |
|---|---|---|
| 000f-e2ff-0041 | VLAN 10 | A2_1 A2_2 A2_3 |
| 000f-e2ff-0042 | VLAN 10 | A2_1 A2_2 A2_3 |
| 000f-e2ff-0043 | VLAN 10 | A2_1 A2_2 A2_3 |
| 000f-ffff-0021 | VLAN 10 | A1_1 |
| 000f-ffff-0001 | VLAN 10 | port1_1 |

The access device 511 may find a matching entry based on the destination MAC address 000f-ffff-0021 and the VLAN 10 of the ARP response packet, and send the ARP Respone to the router device 521 via the port A1_{—}1 in the found entry (shown the fifth row in table 4-1).

The router device 521 may learn an ARP entry corresponding to the IP address of the host 501 based on the sender MAC address and the sender IP address in the received ARP response packet, and learn the MAC address of the host 501 based on the source MAC address 000f-ffff-0001 in the received ARP response packet.

The router device 521 may encapsulate the downstream layer-3 packet into an Ethernet packet, in which the source MAC address is 000f-ffff-0021, the destination MAC address is 000f-ffff-0001, and the VLAN ID is VLAN 10. The router device 521 may send the Ethernet packet via a output port in the learned ARP entry of IP address 10.1.1.01.

In FIG. 5, the access device 511 or 512 may select the output ports in the static entries based on different hash algorithms, which is not described in detail in this example.

The access device 511 and 512 may establish a link state monitoring session, such as a BFD session, with each member device in the VRRP group. The link state monitoring session may be used to monitor the state of the link between access device 511˜512 and the router devices in the VRRP group.

When the access device 511 or 512 detects that one of the ports A1_{—}1˜A1_{—}3 is on a failed link, the access device 511 or 512 may delete the port on the failed link from the static entries. When the access device 511 or 512 detects that the failed link has been recovered, the access device 511 or 512 may add the port on the recovered link to the static route entries.

In the present disclosure, the above examples may be used to perform layer-3 forwarding for east-west traffic between different t network segments of the LAN and north-west traffic between the LAN and an external network.

It should be noted that in the present disclosure, in order to enhance the processing efficiency of the access devices, all of the operations performed by the above access devices may be implemented via hardware and/or software in the access devices.

The methods provided by the present disclosure are described above. The access devices provided by the present disclosure are described hereinafter.

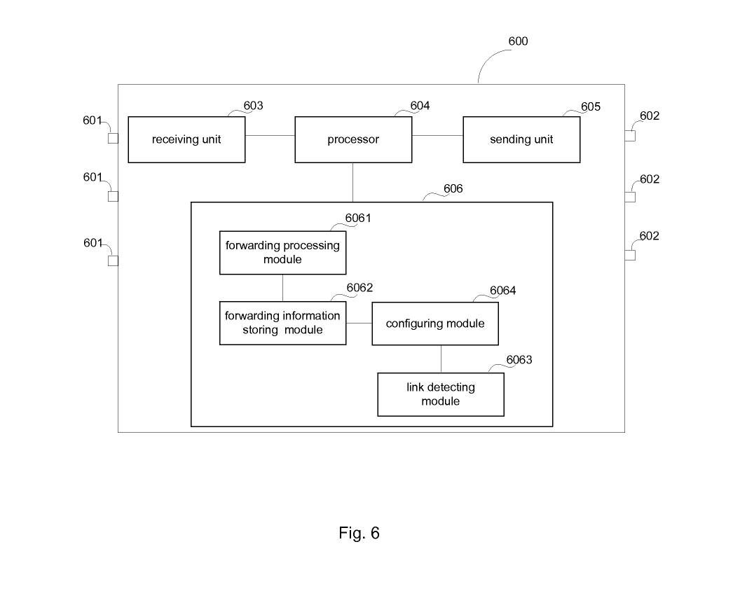

An example of the present disclosure also provides a network switch, as shown in FIG. 6. The network switch 600 may include ports 601, ports 602, a receiving unit 603, a processor 604, a sending unit 605, and a storage 606. Each of the ports 601 may connect to a host. Each of the ports 602 may connect one member device of a VRRP router working as a gateway. The storage 606 may include one or more program modules to be executed by the processor 604, the one or more program modules may include: a forwarding processing module 6061, a forwarding information storing module 6062, a link detecting module 6063 and a configuring module 6064. The network switch may be implemented as an access device in a LAN.

The receiving unit 603 may receive an Ethernet packet of which a destination MAC address is a MAC address of the gateway via any of the ports 601. The forwarding processing module 6061 may select one port from the ports 602 and the sending unit 605 may send the Ethernet packet via the selected port.

The forwarding information storing module 6062 may store a layer-3 forwarding table and a layer-2 forwarding table. The layer-3 forwarding table may store a route entry in which the multiple ports are stored as output ports. The layer-2 forwarding table may store a layer-2 entry with layer-3 attribute for the MAC address of the gateway. The forwarding processing module 6061 may search a layer-2 forwarding table with the destination MAC address, find the layer-2 forwarding entry with layer-3 attribute, search the layer-3 forwarding table with a destination IP address of the received Ethernet packet, find the route entry, and select one output from the output ports in the route entry. The sending unit 605 may send the received Ethernet packet via the output port selected from the route entry. The link detecting module 6063 may detect links, each of which may connect one of the ports 602 to one member device. The configuring module 6064 may delete a port 603 on a failed link from the output ports in the route entry and may add a port 603 on a recovered link to the output ports in the route entry.

The forwarding information storing module 6062 may further store a layer-2 forwarding entry of which the output ports are ports 602 for the MAC address of the gateway in the layer-2 forwarding table. The forwarding processing module 6061 may search the layer-2 forwarding table with the destination MAC address of the received Ethernet packet, find the layer-2 forwarding entry corresponding to the MAC address of the gateway, and select one of the output ports in the found layer-2 forwarding entry corresponding to the MAC address of the gateway. The sending unit 605 may send the received Ethernet packet via the selected output port in the layer-2 forwarding entry corresponding to the MAC address of the gateway. The configuring module 6064 may delete a port on a failed link from the output ports in the layer-2 forwarding entry corresponding to the MAC address of the gateway and may add a port on a recovered link to the output ports in the layer-2 forwarding entry corresponding to the MAC address of the gateway.

It should be noted that the above examples of the present disclosure not only apply to the IPv4 network, but may also apply to the IPv6 network. The host and the default gateway may apply for the MAC address of each other via a Neighbor Discover (ND) protocol packet. In examples of FIGS. 2 and 3, the IP prefix and the mask in the default route entry may vary based on IP address of VLAN 10.

It can be seen from the above examples that in the present disclosure, the access device may balance the Ethernet packets from the hosts to the default gateway for layer-3 forwarding to each member device of the virtual router.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, or programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further, the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the method recited in the examples of the present disclosure.

All or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be a diskette, CD, ROM (Read-Only Memory) or RAM (Random Access Memory), etc.

The figures are only illustrations of examples, in which the modules or procedures shown in the figures may not be necessarily essential for implementing the present disclosure. The modules in the aforesaid examples may be combined into one module or further divided into a plurality of sub-modules.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A packet forwarding method, said method comprising:
receiving an Ethernet packet having a destination media access control (MAC) address that is a MAC address of a gateway;
selecting a port from multiple ports, wherein each of the ports of the multiple ports connects to a respective member device of a virtual router redundancy protocol (VRRP) router that is working as the gateway; and
sending the Ethernet packet via the selected port.

2. The method according to claim 1, wherein the multiple ports are stored as output ports in a default route entry, the method further comprising:
searching a layer-2 forwarding table with the destination MAC address;
finding a matching layer-2 forwarding entry with layer-3 attribute;
searching a layer-3 forwarding table with a destination IP address of the Ethernet packet;
finding the default route entry;
selecting one output port form the output ports in the default route entry; and
sending the Ethernet packet via the selected output port.

3. The method according to claim 1, wherein the multiple ports are stored as output ports in a layer-2 forwarding entry corresponding to the MAC address of the gateway; the method further comprising:
searching a layer-2 forwarding table with the destination MAC address;
finding the layer-2 forwarding entry corresponding to the MAC address of the gateway;
selecting one output port from the output ports in the layer-2 forwarding
entry corresponding to the MAC address of the gateway; and
sending the Ethernet packet via the selected output port.

4. The method according to claim 2, further comprising:
detecting links, wherein each of the links connects one port of the multiple ports to one member device;
deleting a port on a failed link from the output ports in the default entry; and
adding a port on a recovered link to the output ports in the default entry.

5. The method according to claim 3, further comprising:
detecting links, wherein each of the links connects one port of the multiple ports to one member device;
deleting a port on a failed link from the output ports in the layer-2 forwarding entry corresponding to the MAC address of the gateway; and
adding a port on a recovered link to the output ports in the layer-2 forwarding entry corresponding to the MAC address of the gateway.

6. An network switch comprising:
a receiving module, a forwarding processing module, a sending module, and multiple ports, wherein each of the ports of the multiple ports connects to a respective member device of a VRRP router that is working as a gateway;
the receiving module is to receive an Ethernet packet, wherein a destination MAC address of the Ethernet packet is a MAC address of the gateway;
the forwarding processing module is to select one port from the multiple ports; and
the sending module is to send the Ethernet packet via the selected port.

7. The network switch according to claim 6, wherein the multiple ports are stored as output ports in a default route entry being stored in a storage;
the forwarding processing module is further to search a layer-2 forwarding table with the destination MAC address, find a matching layer-2 forwarding entry with layer-3 attribute, search a layer-3 forwarding table with a destination IP address of the Ethernet packet, find the default route entry, and select one output port from the output ports in the default route entry; and
the sending module is further to send the Ethernet packet via the selected output port.

8. The network switch according to claim 6, wherein the multiple ports are stored as output ports in a layer-2 forwarding entry stored in a storage and corresponds to the MAC address of the gateway;
the forwarding processing module is further to search a layer-2 forwarding table with the destination MAC address; find the layer-2 forwarding entry corresponding to the MAC address of the gateway; and select one output port from the output ports in the layer-2 forwarding entry corresponding to the MAC address of the gateway; and
the sending module is to send the Ethernet packet via the selected output port.

9. The network switch according to claim 7, further comprising:
a link detecting module and a configuring module; wherein,
the link detecting module is to detect links, wherein each of the links connects one of the multiple ports to one member device; and
the configuring module is further to delete a port on a failed link from the output ports in the route entry, and add a port on a recovered link to the output ports in the route entry.

10. The network switch according to claim 8, further comprising a link detecting module and a configuring module; wherein,
the link detecting module is to detect links, wherein each of the links connects one of the multiple ports to one member device; and
the processing module is further to delete a port on a failed link from the output ports in the layer-2 forwarding entry corresponding to the MAC address of the gateway; and add a port on a recovered link to the output ports in the layer-2 forwarding entry corresponding to the MAC address of the gateway.
